(19) United States
(12) Patent Application Publication
(10) Pub. No.: US 2010/0017587 A1
(43) Pub. Date: Jan. 21, 2010

(54) Method and system for securing an option ROM configuration

(76) Inventors: Scotty M. Wiginton, Tomball, TX (US); Scott B. Marcak, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/219,083

(22) Filed: Jul. 16, 2008

(51) Int. Cl. G06F 15/177

(52) U.S. Cl. 713/1

(57) ABSTRACT

A method and system are disclosed to secure option read-only memory (ROM) configuration by calling a get user input function, determining if the user input is an option ROM configuration input sequence that allows a user to interact with an option ROM, performing one or more filtering checks on the user input, and conditionally returning the user input to the option ROM. The filtering checks are used to enforce security policies such as prompting for a password, blocking all option ROM configuration input sequence from reaching the option ROM, not allowing option ROM configuration in certain boot environments, and the like.

### BACKGROUND

When a computer system is powered on, a basic input/output system (system BIOS) performs a power-on self test (POST), which includes initializing hardware, testing memory, testing devices, and the like. Some of the hardware devices may require a read-only memory (ROM) with initialization code specific to the device. This ROM-based device initialization code is known as an option ROM. An example of an option ROM is the VGA BIOS found on all standard PC video cards. The system BIOS initializes each option ROM detected during POST. Some of the option ROMs include built-in configuration or setup utilities. A system administrator may want to restrict access to these configuration utilities to prevent users from inadvertently changing settings that would render parts of the computer system unusable. Access restrictions would also keep malicious users from intentionally compromising or corrupting parts of the computer system.

An existing solution includes not executing the option ROMs' initialization code, thus preventing the execution of the option ROMs entirely. This solution, however, limits the functionality of the system. Another solution suppresses the option ROM prompt behind a graphics screen to hide the display of the input sequence needed to enter the configuration utility. However, this solution does not prevent users with prior knowledge from entering the input sequence or accidentally entering the input sequence, such as configuration keys on the keyboard, i.e., hot keys.

### SUMMARY

A computer-implemented method for securing an option ROM configuration on a computer system includes determining if a user input is an option ROM configuration input sequence that allows a user to interact with an option ROM, performing one or more filtering checks on the user input, and conditionally returning the user input that is the option ROM configuration input sequence to the option ROM.

A system for securing an option ROM configuration includes an option ROM and a basic input/output system (system BIOS) that determines if a user input is an option ROM configuration input sequence that allows a user to interact with the option ROM, and perform one or more filtering checks on the user input. If the user input passes the filtering checks, the system BIOS returns the user input to the option ROM. If the user input fails one of the filtering checks, the system BIOS returns an alternate input or no input at all.

A computer readable medium provides instructions for securing an option ROM configuration. The instructions are executed on a computer and include determining if a user input is an option ROM configuration input sequence that allows a user to interact with an option ROM, performing one or more filtering checks on the user input, and conditionally returning the user input that is the option ROM configuration input sequence to the option ROM.

### BRIEF DESCRIPTION OF THE DRAWINGS

Exemplary embodiments of the method and system for securing an option ROM configuration will be described in detail with reference to the following figures, in which like numerals refer to like elements, and wherein:

FIG. 1 illustrates an exemplary system for securing an option ROM configuration;

FIG. 2 illustrates exemplary hardware components of a computer that may be used in connection with the system for securing the option ROM configuration;

FIG. 3 is a flow chart illustrating an exemplary method for securing the option ROM configuration.

### DETAILED DESCRIPTION

Before one or more embodiments of the method and system for securing an option ROM configuration are described in detail, one skilled in the art will appreciate that the method and system for securing the option ROM configuration are not limited in their application to the details of construction, the arrangements of components, and the arrangement of steps set forth in the following detailed description or illustrated in the drawings. The method and system for securing the option ROM configuration are capable of other embodiments and of being practiced or being carried out in various ways. Also, the phraseology and terminology used herein is for the purpose of description and should not be regarded as limiting.

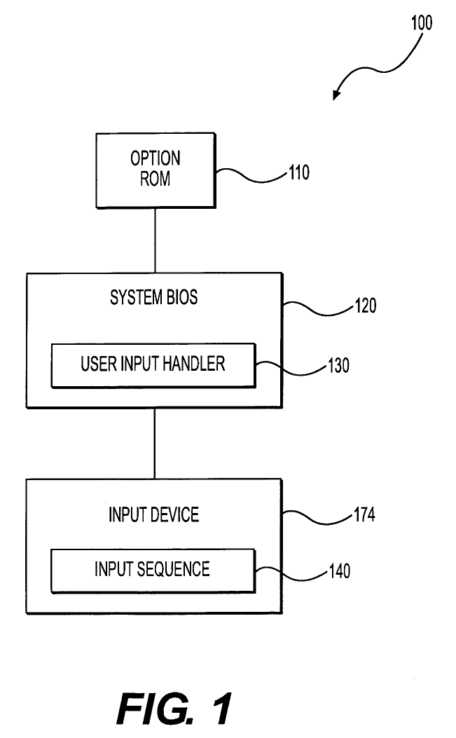

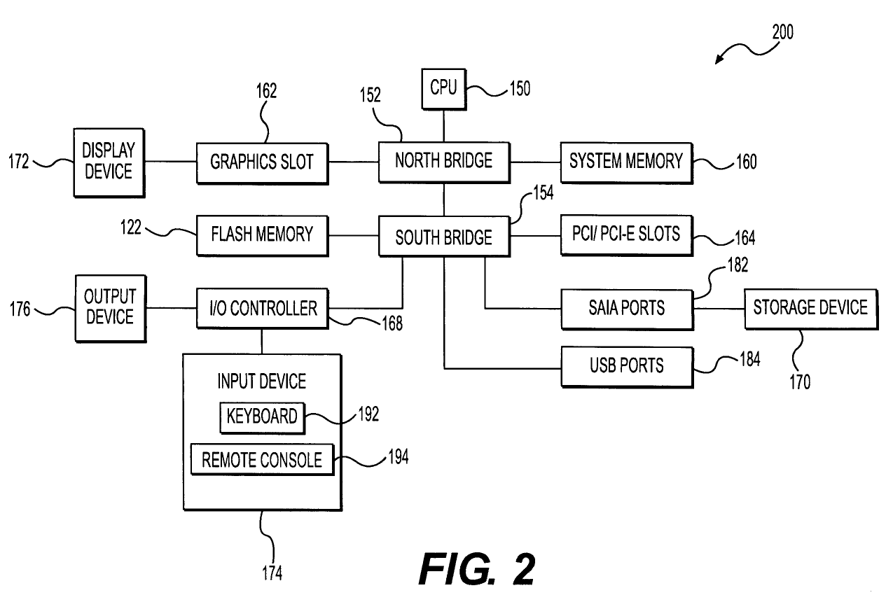

FIG. 1 illustrates an exemplary system 100 for securing an option ROM configuration. The system 100 includes a basic input/output system (system BIOS) 120 that identifies and initiates component hardware on a computer system when the computer system is first powered on. The system BIOS 120 typically resides on a flash memory 122 (shown in FIG. 2). At power-on, the system BIOS 120 is loaded into a system memory 160 (shown in FIG. 2) and executed by a central processing unit (CPU) 150 (shown in FIG. 2) to perform a power-on self test (POST), which includes initializing hardware, testing memory, testing devices, and the like. Some of the hardware devices may need an option ROM 110, which is a ROM on an option card or in the flash memory and includes firmware that is called by the system BIOS 120. For example, a plug-in video or network card may have an option ROM with code needed for that device to function. The system BIOS 120 executes the option ROM 110 for all detected hardware devices. The option ROM 110 may be initialized to intercept system interrupts in order to provide increased functionality to the computer system.

The option ROM 110 may provide a user interface to a configuration utility that enables a user to interact with the option ROM 110. For example, a network interface card (NIC), which is an embedded or add-in computer hardware device that allows computers to communicate over a computer network, may include a pre-boot execution environment (PXE) option ROM that allows a user to configure PXE boot options. PXE is an environment to boot computers over a network, i.e., booting an image provided by a network server instead of the image on a local disk drive. The PXE option ROM is the piece of software code embedded on the NIC that controls this functionality. Similarly, a redundant array of inexpensive disks (RAID) option ROM may provide a user interface for configuring RAID volumes. RAID employs the simultaneous use of multiple physical hard disk drives to achieve greater levels of performance, speed, reliability, quick drive failure recovery, and larger data volume sizes.

The option ROM configuration user interface may be activated when a user enters an option ROM configuration input sequence 140, i.e., input sequence, which is entered through an input device 174. The option ROM configuration input sequence 140 may be optionally identified on a computer screen. The user can access the configuration utility by entering the option ROM configuration input sequence 140 during POST. One skilled in the art will appreciate that the option ROM configuration user interface can include many types of user input or combinations of input. For example, the user may be instructed to press CTRL+S, i.e., press the CTRL and S keys simultaneously, on a keyboard to enter a network interface card (NIC) setup utility to modify the NIC behavior and settings.

The system 100 for securing the option ROM configuration captures the option ROM configuration input sequence 140 while the option ROM 110 is executing. Specifically, the option ROM 110 occasionally calls get user input functions, such as an Int16h “getkeystroke” function. Int16h is a service provided by the system BIOS 120 that manages a keyboard 192 or remote console 194 (both shown in FIG. 2) by reading the contents of an input device buffer, such as a keyboard buffer, to determine if a key has been pressed and, if so, which key has been pressed. Int16h with an input parameter of AH (a processor register)=00h is the get keystroke function call, i.e., read keyboard input.

After the get user input function call is made by the option ROM 110, the control goes back to the system BIOS 120. The system BIOS 120 uses, for example, a user input handler 130, such as an Int16h keyboard input handler, to check if a pending user input, such as a keystroke or keystroke combination, is the option ROM configuration input sequence 140 that allows the user to modify configuration settings. If the user input is not the option ROM configuration input sequence 140, the system BIOS 120 returns the user input to the option ROM 110 to be processed by the option ROM 110. If, however, the user input is the option ROM configuration input sequence 140, the system BIOS 120 performs one or more of filtering checks, i.e., security checks, on the user input.

The filtering checks can be used to enforce a security policy such as prompting for a password, and returning the user input to the option ROM 110 to be processed only when a valid password is entered. If an invalid password is entered, the system BIOS 120 may return a different, benign input to the option ROM 110 or no input at all. In effect, the option ROM configuration input sequence 140 pressed by the user is not transmitted to the option ROM 110.

The filtering checks can be used to enforce a security policy such as preventing users from making changes to the option ROM settings. If this policy is enabled, the system BIOS 120 blocks all option ROM configuration input sequences 140 from reaching the option ROM 110. Instead, the system BIOS returns a different, benign input to the option ROM 110 or no input at all.

The filtering checks can be used to enforce a security policy such as not allowing option ROM configuration in certain boot environments. For example, if the computer system is remotely powered on by a remote wake-up request over a network, the system BIOS 120 may block all option ROM configuration input sequences 140 from reaching the option ROM 110 and return a different, benign input to the option ROM 110 or no input at all.

Since the system BIOS 120 controls the execution of each option ROM 110 detected on the computer system, the system BIOS 120 can control when the user input needs to be filtered. Since the system BIOS 120 also provides the user input functions called by the option ROM 110 to process the user input, the system BIOS 120 can control what input values are returned to the option ROM 110. For example, when a user presses the CTRL+S keys, i.e., the NIC option ROM configuration key to enter a NIC setup utility, the user input handler 130 can filter these specific input sequences, such as keystrokes, while the NIC option ROM is executing. The NIC option ROM configuration input sequences are returned to the NIC option ROM only if the input sequences pass the filtering checks.

FIG. 2 illustrates exemplary hardware components of a computer 200 that may be used in connection with the system 100 for securing the option ROM configuration. The computer 200 may include a connection with a network such as the Internet or other type of computer or telephone network. The computer 200 includes a processor 150, such as a central processing unit (CPU), which is connected to a north bridge (NB) chip 152. A north bridge (NB) chip 152 may be used to control the system memory 160. The system memory 160 may include random access memory (RAM) or similar types of memory.

The computer 200 further includes a display device 172, which may be any type of device for presenting a visual image, such as, for example, a computer monitor, flat-screen display, or display panel. The display device 172 is connected to the computer 200 through a graphics slot 162, which is referred to as external graphics. Alternatively, the display device 172 may be connected to the computer 200 through a direct connection to the NB chip 152 without a graphics slot, which is referred to as integrated graphics.

The computer 200 also includes peripheral component interconnect (PCI) slots and/or PCI Express (PCI-E) slots (collectively 164) for attaching peripheral devices to the computer's motherboard. The computer 200 may also include serial advanced technology attachment (SATA) ports 182 and universal serial bus (USB) ports 184 for transferring data between the computer 200 and storage devices, such as hard disk drives, optical drives, and USB flash drives. The computer 200 also includes secondary storage devices, which are connected to the processor 150 through the SATA ports 182, for example. A south bridge (SB) chip 154 may be used to control the secondary storage devices 170 and other computer devices. The secondary storage devices 170 may include a hard disk drive, floppy disk drive, CD-ROM drive, or other types of non-volatile data storage, and may correspond with various databases or other resources.

As noted above, the system BIOS 120 resides on the flash memory 122, which is attached to the SB chip 154. The NB chip 152 and the SB chip 154 are part of a chipset. The chipset is referred to as the NB chip 152 and the SB chip 154 based on the positioning of the two chips on the motherboard. The computer 200 may alternatively contain only one chip by further integrating the NB chip 152 and the SB chip 154.

At power-on, the system BIOS 120 is loaded into the system memory 160 and executed by the CPU 150. During execution of the system BIOS 120, devices installed in peripheral slots of the computer 200, such as the graphics slot 162 and the PCI/PCI-E slots 164, are initialized. If any of these devices need an option ROM 110, the system BIOS 120 loads the option ROM image into the system memory 160, enables filters in the get user input function routines, and executes the option ROM 110. When the option ROM initialization is complete, thus ending the window of opportunity for the user to enter the option ROM configuration input sequence 140, the system BIOS 120 unloads the unneeded portion of the option ROM image from the system memory 160 and stops the filtering of the get user input function routines.

The processor 150 may execute instructions stored in the system memory 160 to perform the method steps described herein. For example, the processor 150 may execute instructions to filter the user input. These instructions may optionally be received from the secondary storage devices 170 or from the Internet or other network.

The computer 200 also includes the input device 174, which may be any device for entering data into the computer 200, such as the keyboard 192, the remote console 194, keypad (not shown), cursor-control device (not shown), touch-screen (possibly with a stylus) (not shown), or microphone (not shown). The input device 174 is connected to the SB chip 154 through an input/output (I/O) controller 168. The I/O controller 168 may be a super I/O controller that combines interfaces for a variety of low-bandwidth devices. The functions provided by the super I/O controller typically include a floppy disk controller, a parallel port that is commonly used for printers, one or more serial ports, and a keyboard and mouse interface. A super I/O controller may also have other interfaces, for example, for a joystick or infrared port.

The computer 200 further includes an output device 176, which may be any type of device for presenting data in hard copy format, such as a printer, and other types of output devices including speakers or any device for providing data in audio form. The output device 176 is connected to the SB chip 154 through the I/O controller 168. The computer 200 can possibly include multiple input devices, output devices, and display devices. The exemplary computer 200 may be a desktop computer, a laptop computer, and other types of computers.

Although the computer 200 is depicted with various components, one skilled in the art will appreciate that the computer 200 can contain additional or different components. In addition, although aspects of an implementation consistent with the system for securing the option ROM configuration are described as being stored in system memories, one skilled in the art will appreciate that these aspects can also be stored on or read from other types of computer program products or computer-readable media, such as secondary storage devices, including hard disks, floppy disks, or CD-ROM; a signal embodied in a carrier wave from the Internet or other network; or other forms of RAM or ROM. The computer-readable media may include instructions for controlling the computer 200 to perform a particular method.

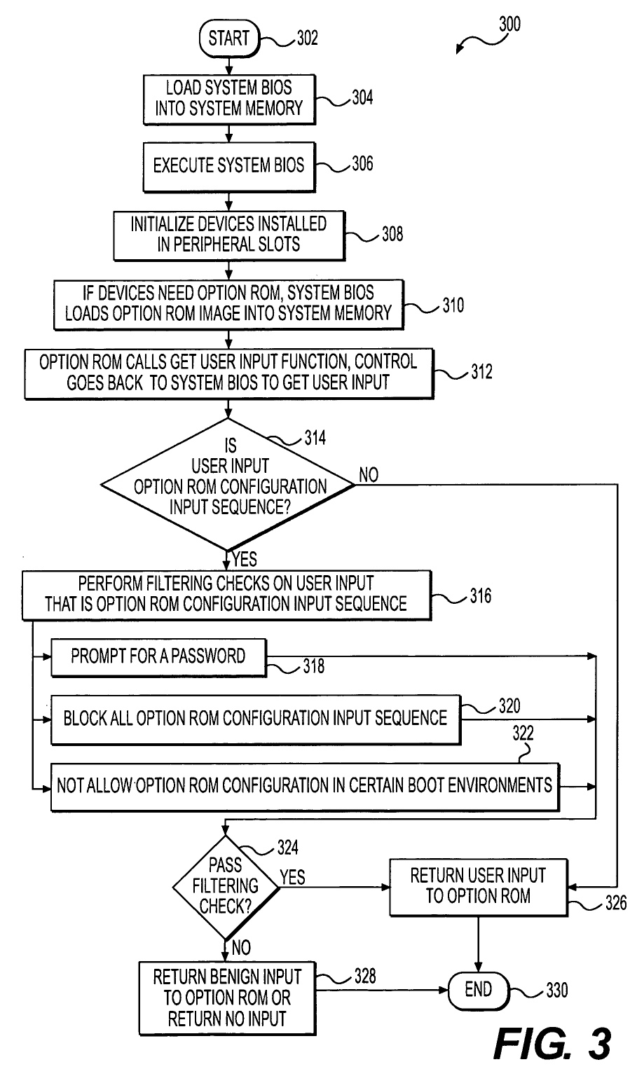

FIG. 3 is a flow chart illustrating an exemplary method 300 for securing the option ROM configuration. The method 300 starts 302 by loading the system BIOS 120 into the system memory 160 (block 304). The CPU 150 executes the system BIOS 120 (block 306), which initializes the devices installed in the peripheral slots (block 308). If any of the devices need an option ROM 110, the system BIOS 120 loads the option ROM image into the system memory 160 (block 310) and executes its initialization code. The option ROM 110 calls the get user input function, such as the Int16h “getkeystroke” function (block 312).

The system BIOS 120 uses, for example, the user input handler 130 to determine if any pending user input, such as a keystroke or keystroke combination, is the option ROM configuration input sequence 140 (block 314). If the user input is not the option ROM configuration input sequence 140, the system BIOS 120 returns the user input to the option ROM 110 to be processed (block 326). If the user input is the option ROM configuration input sequence 140, the system BIOS 120 performs one or more filtering checks on the user input that is the option ROM configuration input sequence 140 (block 316). The filtering checks may enforce security policies such as prompting for a password (block 318), blocking all option ROM configuration input sequence 140 from reaching the option ROM (block 320), and not allowing option ROM configuration in certain boot environments (block 322). For example, the method 300 determines a mode in which the computer system is running. If the computer system is remotely powered on, the method blocks the option ROM configuration input sequence 140 from reaching the option ROM.

If the user input passes the filtering checks (block 324), the system BIOS 120 returns the user input to the option ROM 110 to be processed (block 326). If the user input does not pass the filtering checks, the system BIOS 120 returns different, benign input to the option ROM 110 (block 328) or does not return any input at all. The method 300 ends at 330.

In the foregoing detailed description, systems and methods in accordance with embodiments of the method and system for securing the option ROM configuration are described with reference to specific exemplary embodiments. Accordingly, the present specification and figures are to be regarded as illustrative rather than restrictive. The scope of the method and system for securing the option ROM configuration is to be further understood by the numbered examples appended hereto, and by their equivalents.

Further, in describing various embodiments, the specification may present a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A computer-implemented method for securing an option read-only memory (ROM) configuration on a computer system, comprising:
determining if a user input is an option ROM configuration input sequence that allows a user to interact with an option ROM;
performing one or more filtering checks on the user input; and
conditionally returning the user input that is the option ROM configuration input sequence to the option ROM.

2. The method of claim 1, further comprising returning the user input that is not the option ROM configuration input sequence to the option ROM.

3. The method of claim 1, further comprising returning a benign input or no input to the option ROM if the user input fails one of the one or more filtering checks.

4. The method of claim 1, wherein the performing step comprises prompting for a password, wherein a valid password allows the user input that is the option ROM configuration input sequence to be returned to the option ROM to be processed.

5. The method of claim 1, wherein the performing step comprises blocking all option ROM configuration input sequence from reaching the option ROM.

6. The method of claim 1, wherein the performing step comprises blocking the option ROM configuration input sequence from reaching the option ROM in certain boot environments.

7. The method of claim 6, wherein the blocking step includes:
determining a mode in which the computer system is running; and
if the computer system is remotely powered on, blocking all option ROM configuration input sequences from reaching the option ROM.

8. The method of claim 1, further comprising using an user input handler to determine if the user input is the option ROM configuration input sequence.

9. The method of claim 1, wherein the option ROM is executed by a basic input/output system (system BIOS).

10. The method of claim 1, further comprising initializing devices installed in peripheral slots that need the option ROM.

11. The method of claim 1, further comprising loading an option ROM image into a system memory and executing the option ROM.

12. The method of claim 1, further comprising calling a get user input function that gets input from an input device buffer.

13. A system for securing an option read-only memory (ROM) configuration, comprising:
an option ROM;
a basic input/output system (system BIOS) that determines if a user input is an option ROM configuration input sequence that allows a user to interact with the option ROM, performs one or more filtering checks on the user input, and conditionally returns the user input that is the option ROM configuration input sequence to the option ROM.

14. The system of claim 13, wherein the system BIOS returns the user input that is not the option ROM configuration input sequence to the option ROM.

15. The system of claim 13, wherein the system BIOS returns a benign input or no input to the option ROM if the user input fails one of the one or more filtering checks.

16. The system of claim 13, wherein the system BIOS prompts for a password, wherein a valid password allows the user input that is the option ROM configuration input sequence to be returned to the option ROM to be processed.

17. The system of claim 13, wherein the system BIOS blocks all option ROM configuration input sequences from reaching the option ROM.

18. The system of claim 13, wherein the system BIOS blocks the option ROM configuration input sequence from reaching the option ROM in certain boot environments.

19. The system of claim 13, wherein the system BIOS uses an user input handler that determines if the user input is the option ROM configuration input sequence.

20. A computer readable medium providing instructions for securing an option read-only memory (ROM) configuration, the instructions being executed on a computer and comprising:
determining if user input is an option ROM configuration input sequence that allows a user to interact with an option ROM;
performing one or more filtering checks on the user input; and
conditionally returning the user input that is the option ROM configuration input sequence to the option ROM.
